(19) United States
(12) Patent Application Publication
(10) Pub. No.: US 2011/0234075 A1
(43) Pub. Date: Sep. 29, 2011

(54) WATER VALVE AND HOUSEHOLD REFRIGERATION UNIT

(75) Inventors: Jose Manuel Lamuela Rosano, Giengen (DE); Hans Peter Werner, Giengen (DE)

(73) Assignee: BSH BOSCH UND SIEMENS HAUSGERÄTE GMBH, Munich (DE)

(21) Appl. No.: 13/131,029

(22) PCT Filed: Nov. 24, 2009
(86) PCT No.: PCT/EP09/65770

§ 371 Date: May 25, 2011

(30) Foreign Application Priority Data
Dec. 19, 2008 (DE) 10 2008 055 009.4

(51) Int. Cl. F25D 23/04; F16K 1/42

(52) U.S. Cl. 312/405.1; 251/360

(57) ABSTRACT

A water valve for a household refrigeration unit includes a housing having a water channel that has a first end having a first opening and a second end having a second opening. A sealing mechanism is arranged within the water channel and movable along the water channel between a closed position in which the sealing mechanism seals the water channel and an open position in which the sealing mechanism opens the water channel. The sealing mechanism includes a first inner seal for sealing the first opening in the closed position thereof and a second inner seal for sealing the second opening in the closed position thereof. Arranged on the outside of the housing are first and second outer seals disposed in offset relationship. The first and second outer seal adjoin a hollow space when installed and seal the water valve from the environment.

The invention relates to a water valve for a water dispenser in a household refrigeration appliance and a household refrigeration appliance with a water valve.

In order to supply cooled water, a household refrigeration appliance, in particular a household refrigerator, can feature a water dispenser, the water container of which is disposed in or on the door of the household refrigerator. In order to be able to remove water, the water dispenser has a water valve, which releases water from the water container when actuated by an operator. The water valve may drip after actuation due to condensate or residual water.

The object of the invention is to specify an improved water valve for a water dispenser in a household refrigeration appliance.

The object of the invention is achieved by a water valve for a water dispenser in a household refrigeration appliance, comprising a housing having a water channel that has a first end with a first opening and a second end with a second opening and a sealing mechanism that is disposed within the water channel and can be moved along the water channel between a closed position in which the sealing mechanism seals the water channel and an open position in which the sealing mechanism opens the water channel, wherein

the sealing mechanism comprises a first inner seal, by means of which the sealing mechanism is able to seal the first opening in its closed position, and a second inner seal, by means of which the sealing mechanism is able to seal the second opening in its closed position, and/or

a first outer seal and a second outer seal, which is disposed offset in relation to the first seal, are provided on the outside of the housing, delimiting a hollow space between them and sealing the water valve off from the environment in the installed state.

A further aspect of the invention relates to a household refrigeration appliance, comprising a refrigeration compartment, a door leaf that is able to seal off the refrigeration compartment, a water container disposed in the door leaf or on the inside of the door leaf, a channel running through the door leaf, connected to the water container and extending to a water outlet disposed on the outside of the door leaf and the inventive water valve, which is disposed in the channel in such a manner that the first opening faces in the direction of the water container, wherein

the first inner seal is in contact with water in the water container when the sealing mechanism is in the closed position and therefore has at least roughly the same temperature as the water and the second inner seal is exposed to the ambient temperature of the household refrigeration appliance, and/or

the first outer seal is in contact with water in the water container and therefore has at least roughly the same temperature as the water and the second outer seal is exposed to the ambient temperature of the household refrigeration appliance.

The inventive household refrigeration appliance is preferably a household refrigerator or combined refrigerator/freezer, in the refrigeration compartment of which the water container is optionally located when the door leaf is closed. The channel is preferably configured as a connector molded onto the water container as a single piece, preferably from the same material.

The inventive water valve therefore comprises the housing with the water channel, which the sealing mechanism is able to seal in its closed position, so that no water can flow from the water container through the water valve, in particular through its water channel, during operation of the inventive household refrigeration appliance. According to the invention the sealing mechanism comprises the two inner seals, of which the first inner seal seals the first opening in the closed position. In the installed state the first opening points in the direction of the water container, so that in the closed position water in the water container is present at the first seal. The water in the water container is cooled by the refrigeration compartment and has a temperature of 4° C. for example.

The second inner seal is provided to seal the second opening in the closed position. In the closed position the water channel therefore forms a chamber, which is sealed by the two inner seals in the closed position. After water has been removed from the water container by means of the inventive water valve, there is therefore water present in this chamber, which can warm up, as the chamber is separated from the water container by the first inner seal. This establishes conditions for reducing or even preventing the condensation of water outside the chamber and after the second inner seal. This allows the dripping of the water valve to be at least reduced, if not completely prevented.

Additionally or alternatively the inventive water valve comprises the two outer seals on the outside of the housing. The two outer seals are optionally disposed between the housing and the channel, in particular the connector of the water container, and prevent or at least reduce any lack of leaktightness between the water container and the water outlet. The provision of at least two outer seals establishes conditions for preventing or at least reducing a temperature exchange, which would result in the condensation of water in the region of the water outlet or in the region of the water container.

The first outer seal can preferably be disposed on the outside of the housing in the region of the first opening and the second outer seal can be disposed on the outside of the housing offset in the direction of the second opening in relation to the first seal.

According to one embodiment of the inventive water valve the water channel is followed by an outflow, with water being able to flow from the water channel by way of the second opening into the outflow when the sealing mechanism is in its open position. The outflow projects for example into the water removal unit and is provided to remove water from the water container by means of the water valve.

In order to prevent or at least reduce the dripping of water from the outflow after water has been removed, according to one variant of the inventive water valve the outflow is embodied in such a manner that it creates a surface tension for water present at the outflow. This can be achieved for example by giving the outflow an oval cross section and/or providing the outflow with a grid.

According to one embodiment of the inventive water valve the housing comprises a hollow space adjoining the second opening of the water channel with a further water channel adjoining said water channel, into which water from the water channel is able to flow by way of the second opening, when the sealing mechanism is in its open position. The sealing mechanism can be disposed at least partially within the hollow space.

According to one variant the inventive water valve can be embodied relatively simply, if the housing is configured in the manner of a hollow cylinder at least in the region of the water channel and/or the first opening forms one of the ends of the housing.

In order optionally to permit relatively simple assembly of the inventive water valve, said water valve can comprise a cover closing off the housing, which is fastened to the housing at the end opposite the first opening by means of a latching device and/or in particular by welding, in particular by ultrasonic welding. The cover can preferably include the outflow, which is molded onto the cover in particular as a single piece, preferably from the same material. Ultrasonic welding in particular establishes conditions for an absence of air penetration between the cover and the housing. Ultrasonic welding permits a seal or vacuum, so that no water flows between the second inner seal and the outflow when the water valve is in its closed position.

In order to move the sealing mechanism from its closed position to its open position, the inventive water valve can have an actuation mechanism which, when actuated, moves the sealing mechanism from its closed position to its open position. The actuation mechanism is preferably embodied as an actuation lever, which allows relatively simple operation.

In order to move the adjustment mechanism from its open position to its closed position, according to one preferred variant the inventive water valve comprises a reset apparatus, which after actuation of the actuation mechanism automatically moves the sealing mechanism from its open position to its closed position. The reset apparatus is for example an appropriately pretensioned spring, in particular a conical spring. The spring is made from stainless spring steel for example.

According to one preferred embodiment of the inventive water valve the sealing mechanism is embodied as a plunger embodied in particular in the manner of a cylinder, on which the first and second seals are disposed. The water channel can then preferably be configured in the manner of a cylinder.

To improve the movement of the sealing mechanism, it can comprise guiding devices, e.g. in the form of guiding wings, that are molded on in particular as a single piece, preferably from the same material, and are passed through corresponding guiding counter devices of the water channel.

The sealing mechanism can preferably be made as a single piece, in particular from a plastic. POM (polyoxymethylene or polyacetal) can preferably be used as the plastic for the sealing mechanism, as it has relatively favorable anti-friction properties.

The housing can be made in particular as a single piece from a plastic, in particular from acryl-nitril-butadien-acrylate.

In order to dispose the inner seals relatively simply on the sealing mechanism, in particular to fix them there, according to one variant of the inventive water valve supports are provided that are molded onto the sealing mechanism as a single piece, in particular from the same material, which are designed to hold the inner seals in particular with a form fit. Alternatively or additionally the outside of the housing can comprise supports that are molded on as a single piece, in particular from the same material, which are designed to hold the outer seals in particular with a form fit.

At least one of the outer seals and/or inner seals can be embodied as a sealing ring and/or made from silicon.

Exemplary embodiments of the invention are illustrated by way of example in the accompanying schematic drawings, in which:

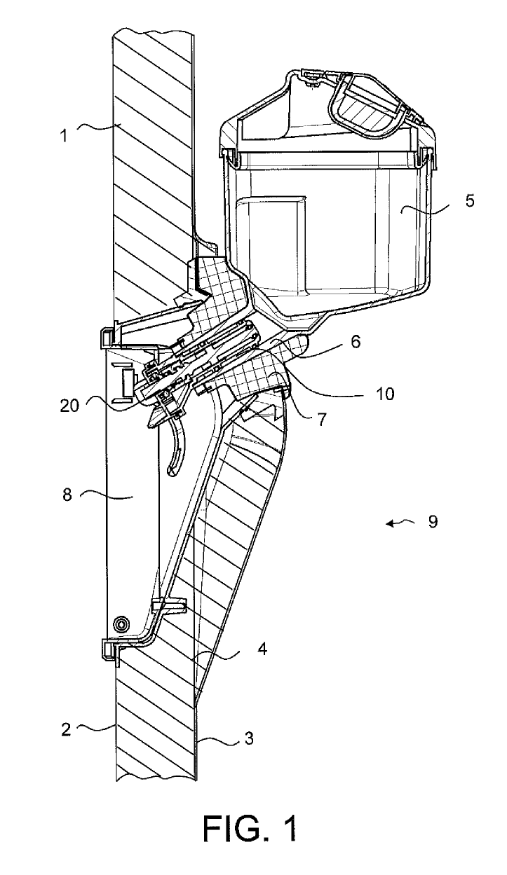

FIG. 1 shows a water dispenser with a water valve disposed in a door leaf of a household refrigerator,

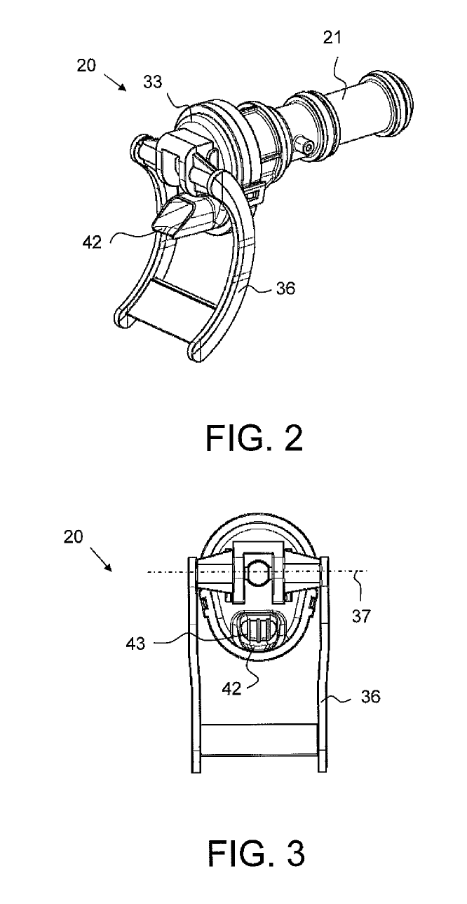

FIG. 2 shows a perspective view of the water valve,

FIG. 3 shows a front view of the water valve with an outflow,

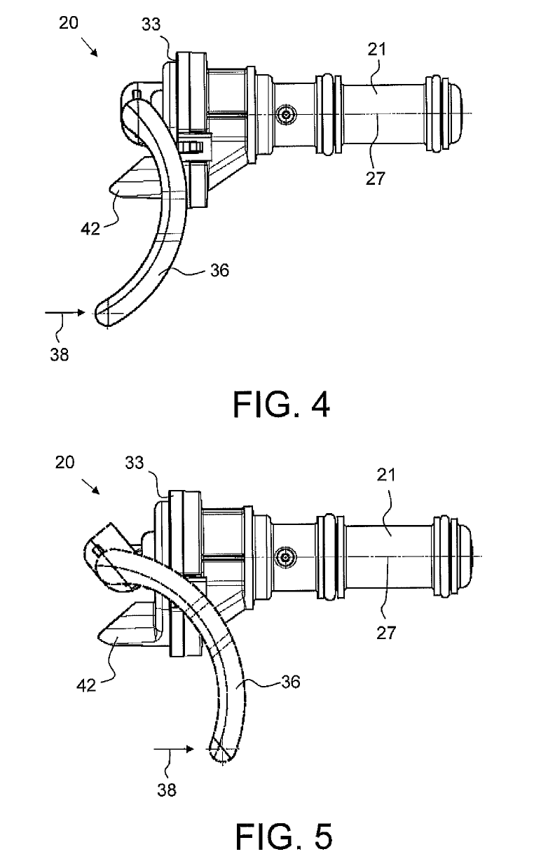

FIGS. 4 and 5 show side views of the water valve,

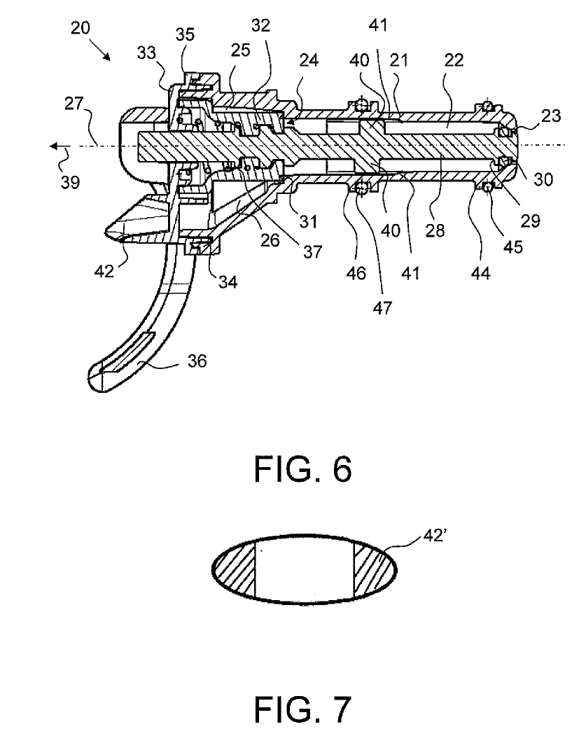

FIG. 6 shows a sectional view of the water valve, and

FIG. 7 shows a cross section through an alternative outflow.

FIG. 1 shows part of a household refrigerator as an example of a household refrigeration appliance. However the household refrigeration appliance can also be a combined refrigerator/freezer.

The household refrigerator comprises a carcass (not shown here) which is generally known, and a door leaf 1 hinged in a pivotable manner to the carcass e.g. by means of hinges. The carcass and door leaf 1 delimit a refrigeration compartment 9 in the generally known manner, said refrigeration compartment 9 being accessible when the door leaf 1 is opened.

The walls of the carcass and the door leaf 1 each comprise in the generally known manner for example an inner skin 3 facing in the direction of the refrigeration compartment 9, an outer skin 2 facing out and an insulation 4, e.g. made from foamed material, enclosed between these.

The refrigeration compartment 9 is cooled by a refrigeration apparatus that is not shown in detail but is generally known to the person skilled in the art and comprises for example an evaporator of a refrigerant circuit coupled operationally to the refrigeration compartment 9.

In the present exemplary embodiment a non-pressurized water container 5 is fastened to the inner skin 3, being also connected in a manner not shown to a water supply network and therefore being able to be filled with water from the network. When the door leaf 1 is closed, the water container 5 is present within the refrigeration compartment 9, so that the water in the water container 5 is cooled.

In its lower region the water container 5 has a connector 6 molded onto the water container 5 and passing through the door leaf 1 and in particular through the insulation 4. A sealing plug 7 (foamed part) is disposed around the connector 6 to seal the water container 5 off from the door leaf 1.

In the present exemplary embodiment a recess 8 is molded in the outer skin 2 of the door leaf 1, with the end of the connector 6 away from the water container 5 opening therein. The recess 8 forms a water outlet for water in the water container 5.

In the present exemplary embodiment a water valve 20 (shown in more detail in FIGS. 2 to 6) is disposed in the connector 6. FIG. 2 shows a perspective view of the water valve 20, FIG. 3 shows a front view of the water valve 20, FIGS. 4 and 5 show side views of the water valve 20 and FIG. 6 shows a sectional view of the water valve 20.

In the present exemplary embodiment the water valve 20 comprises a housing 21 in the manner of a hollow cylinder made for example from a plastic, in particular from acryl-nitril-butadien-acrylate (ABS). An essentially cylindrical first water channel 22 is disposed in the interior of said housing 21. The first water channel 22 extends from a first opening 21 flush with the housing 21 to a second opening 24 disposed within the housing 21. When the water valve 20 is disposed in the connector 6, the first opening 23 faces in the direction of the water container 5, so that the first opening is in contact with the water in the water container 5.

In the present exemplary embodiment the housing 21 comprises a hollow space 25 adjoining the first water channel 22, which is partially configured as a second water channel 26 adjoining the first water channel 22.

Disposed in the interior of the housing 21 is a for example essentially cylindrical plunger 28 that can be moved along its longitudinal axis 27 and is made for example from a plastic, in particular from POM (polyoxymethylene or polyacetal). The plunger 28 is provided to seal the two openings 23, 24 in a first operating state shown in FIGS. 4 and 6, so that no water can flow out of the water container 5 through the first opening 23 into the first water channel 22. In a second operating state, as shown for example in FIG. 5, the plunger 28 releases the two openings 23, 24, so that water can flow from the water container 5 through the first opening 23 into the first water channel 22 and through the second opening 24 into the second water channel 26.

In order to close off or seal the first opening 23 as required, in the present exemplary embodiment the plunger 28 has a support 29 for a first inner seal 30 on its end facing the first opening 23. The first inner seal 30 is configured in the manner of an O ring for example and is made from silicon. During operation of the household refrigerator water in the water container 5 is present at the inner seal 30 even in the sealed state (first operating state), so that the temperature of the first inner seal 30 corresponds roughly to the temperature of the water in the water container 5. The temperature of the water corresponds roughly to the temperature of the refrigeration compartment 9 and is for example around 4° C.

In the region of the second opening 24 the first water channel 22 and the hollow space 25 form an edge 31. A second inner seal 32 is also disposed on the plunger 28, being made from silicon for example and being disposed on the periphery of the plunger 28. When the water valve 20 is in the closed state, the second inner seal 32 rests against the edge 31, to seal the second opening 24.

In the present exemplary embodiment the water valve 20 comprises a cover 33, made from ABS plastic for example, which seals the housing 21 at the end facing away from the first opening 23. The housing 21 has latching devices 34 and the cover 33 has counter latching devices 35, which in the present exemplary embodiment were latched with one another during assembly of the water valve 20 and were then welded using ultrasound.

Supported on the cover 33 is an actuation lever 36 made for example from plastic, in particular from a PA (polyamide) plastic, which can be pivoted about an axis of rotation 37. The actuation lever 36 interacts with the plunger 28 and is provided to move the plunger 28 along its longitudinal axis 27. If the actuation lever 36 is not actuated, a conical spring 37, made for example of stainless spring steel and interacting with the plunger 28, pushes the plunger 28 with its first inner seal 30 against the first opening 23 and with its second inner seal 32 against the second opening 24 or against the edge 31, as shown in FIG. 6.

If the actuation lever 36 is actuated, by being pushed in the direction of an arrow 38 by means of a glass (not shown), the actuation lever 36 pivots relative to its axis of rotation 37 and moves the plunger 28 in the direction of an arrow 39. This causes the plunger 28 to release the two openings 23, 24, so that water can flow from the water container 5 through the first opening 23 into the first water channel 22 and through the second opening 24 into the second water channel 26.

To guide the plunger 28 more effectively in the present exemplary embodiment it has guiding wings 40 that are molded on as a single piece, in particular from the same material, which run in guides 41 disposed in the first water channel 22.

An outflow 42 for discharging water in the water container 5 is molded onto the cover 33 for example as a single piece, in particular from the same material, said outflow 42 adjoining the second water channel 26. In the installed state the outflow 42 projects into the recess 8 so that water flowing through the first and second channels 22, 26 can be removed from the water valve 20 by way of the outflow 42.

In the present exemplary embodiment the outflow 42 has a grid 43, which is provided for example to prevent or at least reduce the dripping of water. The outflow 42 is also embodied so that it creates a surface tension for water present at the outflow 42 to prevent dripping.

FIG. 7 shows an alternative embodiment of the outflow, marked with the reference character 42′. To create a surface tension for water present at the outflow 42′, said outflow 42′ has an oval cross section in the present exemplary embodiment.

In the present exemplary embodiment the second inner seal 32 is exposed to the ambient temperature of the household refrigerator by way of the outflow 42 and the second water channel 26.

In order to seal the installed water valve 20 off from the door 1 of the household refrigerator, the outside of the housing 21 has a first support 44 for a first outer seal 45 and a second support 46 for a second outer seal 47. The two outer seals 45, 47 are configured for example as O rings (sealing rings) and are made from silicon. The two outer seals 45, 47 are disposed respectively on the outer periphery of the housing 21 and when the water valve 20 is disposed in the connector 6, they are located between the outside of the housing 21 and the connector 6. The two outer seals 45, 47, the housing 21 and the connector 6 therefore form a hollow space 10.

The first support 44 for the first outer seal 45 is molded onto the housing as a single piece, in particular from the same material, close to the end assigned to the first opening 23, so that the first outer seal 45 is disposed close to the inner skin 3 of the door leaf 1 in the connector 6 and can come into contact with the cooled water in the water container 5 during operation of the household refrigerator. During operation of the household refrigerator the temperature of the water in the water container 5 corresponds roughly to the temperature of the refrigeration compartment 9 and is for example around 4° C.

The second support 46 for the second outer seal 47 is molded onto the housing 21 as a single piece, in particular from the same material, so that both outer seals 45, 47 are aligned parallel to one another. In the installed state an air bridge results between the second outer seal 47 and the environment of the household refrigerator, so that the temperature of the second outer seal 47 can correspond to the ambient temperature of the household refrigerator.

1-15. (canceled)

16. A household refrigeration appliance, comprising:
a refrigeration compartment;
a door leaf for sealing the refrigeration compartment, said door leaf having a water outlet on an outside thereof;
a water container disposed in the door leaf or on an inside of the door leaf and connected to the water outlet by a channel running through the door leaf; and
a water valve disposed in the channel and comprising
a housing having a first water channel having a first end with a first opening facing in a direction of the water container, and a second end with a second opening,
a sealing mechanism disposed within the first water channel and movable along the first water channel between a closed position in which the sealing mechanism seals the first water channel and an open position in which the sealing mechanism opens the first water channel,
a first outer seal disposed on an outside of the housing, and
a second outer seal disposed on the outside of the housing in offset relation to the first outer seal, said first and second outer seals delimiting a hollow space and sealing the water valve against the environment.

17. The household refrigeration appliance of claim 16, wherein the first outer seal is in contact with water in the water container and has at least roughly a same temperature as the water, and wherein the second outer seal is exposed to an ambient temperature of the household refrigeration appliance.

18. The household refrigeration appliance of claim 16, wherein the sealing mechanism comprises a first inner seal for enabling the sealing mechanism to seal the first opening in the closed position, and a second inner seal for enabling the sealing mechanism to seal the second opening in the closed position.

19. The household refrigeration appliance of claim 18, wherein the first inner seal is in contact with water in the water container when the sealing mechanism is in the closed position and has at least roughly a same temperature as the water, and wherein the second inner seal is exposed to an ambient temperature of the household refrigeration appliance.

20. The household refrigeration appliance of claim 16, wherein the first outer seal is disposed on the outside of the housing in a region of the first opening and the second outer seal is disposed on the outside of the housing offset in a direction of the second opening in relation to the first seal.

21. The household refrigeration appliance of claim 16, wherein the first water channel is followed by an outflow, with water being able to flow from the first water channel via the second opening into the outflow when the sealing mechanism is in the open position.

22. The household refrigeration appliance of claim 21, wherein the outflow is configured to create a surface tension for water present at the outflow, said outflow having an oval cross section.

23. The household refrigeration appliance of claim 21, further comprising a grid arranged in the outflow.

24. The household refrigeration appliance of claim 16, wherein the housing comprises a hollow space adjoining the second opening of the first water channel and forming a second water channel which adjoins the first water channel and receives water from the first water channel via the second opening, when the sealing mechanism is in the open position.

25. The household refrigeration appliance of claim 24, wherein the second water channel receives water from the first water channel via the second opening, when the sealing mechanism is disposed at least partially within the hollow space.

26. The household refrigeration appliance of claim 16, wherein the housing is configured in the manner of a hollow cylinder at least in a region of the first water channel.

27. The household refrigeration appliance of claim 16, wherein the first opening forms one of the ends of the housing.

28. The household refrigeration appliance of claim 16, further comprising a cover closing off the housing and fastened to the housing at a housing end opposite the first opening.

29. The household refrigeration appliance of claim 28, wherein the cover is fastened to the housing by a latching device.

30. The household refrigeration appliance of claim 28, wherein the cover is fastened to the housing by welding.

31. The household refrigeration appliance of claim 28, wherein the cover is fastened to the housing by ultrasonic welding.

32. The household refrigeration appliance of claim 28, wherein the cover includes an outflow in communication with the first water channel when the sealing mechanism is in the open position.

33. The household refrigeration appliance of claim 16, further comprising an actuation mechanism which, when actuated, moves the sealing mechanism from the closed position to the open position.

34. The household refrigeration appliance of claim 33, further comprising a cover closing off the housing and fastened to the housing at a housing end opposite the first opening, said the actuation mechanism being constructed as an actuation lever which is pivotally mounted to the cover.

35. The household refrigeration appliance of claim 33, further comprising a reset apparatus which after actuation of the actuation mechanism automatically moves the sealing mechanism from the open position to the closed position.

36. The household refrigeration appliance of claim 35, wherein the reset apparatus includes a pretensioned spring.

37. The household refrigeration appliance of claim 16, wherein the sealing mechanism is embodied as a plunger, on which the first and second outer seals are disposed.

38. The household refrigeration appliance of claim 37, wherein the plunger is configured in the manner of a cylinder.

39. The household refrigeration appliance of claim 16, wherein the first water channel is configured in the manner of a cylinder.

40. The household refrigeration appliance of claim 16, wherein the sealing mechanism is made as a single piece.

41. The household refrigeration appliance of claim 16, wherein the sealing mechanism is made from a plastic.

42. The household refrigeration appliance of claim 41, wherein the sealing mechanism is made from polyoxymethylene or polyacetal.

43. The household refrigeration appliance of claim 16, wherein the housing is made as a single piece from a plastic.

44. The household refrigeration appliance of claim 43, wherein the housing is made from acryl-nitril-butadien-acrylate.

45. The household refrigeration appliance of claim 18, further comprising supports configured in at least one of two ways, a first way in which the supports are molded onto the sealing mechanism as a single piece and constructed to hold the first and second inner seals, a second way in which the supports are molded onto the outside of the housing as a single piece to hold the first and second outer seals.

46. The household refrigeration appliance of claim 45, wherein the supports and the sealing mechanism are made from a same material.

47. The household refrigeration appliance of claim 45, wherein the supports hold the first and second inner seals with a form fit.

48. The household refrigeration appliance of claim 45, wherein the supports and the housing are made from a same material.

49. The household refrigeration appliance of claim 45, wherein the supports hold the first and second outer seals with a form fit.

50. The household refrigeration appliance of claim 18, wherein at least one of the outer seals and/or the inner seals is constructed as a sealing ring.

51. The household refrigeration appliance of claim 50, wherein the at least one of the outer seals and/or the inner seals is made from silicon.

52. The household refrigeration appliance of claim 16, wherein the channel is configured as a connector molded onto the water container as a single piece.

53. The household refrigeration appliance of claim 52, wherein the connector and the water container are made from a same material.
